(19) United States
(12) Patent Application Publication
(10) Pub. No.: US 2012/0090541 A1
(43) Pub. Date: Apr. 19, 2012

(54) WORKPIECE CARRIER AND DEPOSITION DEVICE HAVING SAME

(75) Inventor: CHUNG-PEI WANG, Tu-Cheng (TW)

(73) Assignee: HON HAI PRECISION INDUSTRY CO., LTD., Tu-Cheng (TW)

(21) Appl. No.: 13/015,586

(22) Filed: Jan. 28, 2011

(30) Foreign Application Priority Data
Oct. 15, 2010 (TW) 99135210

(51) Int. Cl. B05C 13/00; B23Q 1/40; B23Q 3/00

(52) U.S. Cl. 118/500; 269/55; 269/61

(57) ABSTRACT

A workpiece carrier includes a first carrier and a second carrier. The first carrier includes a plurality of first posts substantially parallel to each other. Each of the first posts is rotatable about a central axis thereof. The second carrier includes a plurality of second posts substantially parallel to each other. Each of the second posts is rotatable about a central axis thereof. The first carrier surrounds the second carrier therein. The workpiece carrier further includes at least one connecting arm interconnected between the first carrier and the second carrier, such that the first carrier and the second carrier are jointly rotatable about a rotation axis.

### BACKGROUND

1. Technical Field

The present disclosure relates to a workpiece carrier and a related deposition device.

2. Description of Related Art

Physical vapor deposition (PVD) devices are widely used to form functional or decorative metallic films on workpieces. A typical PVD device usually includes a deposition chamber, and a workpiece carrier positioned in the deposition chamber. The workpiece carrier is a single assembly with a number of posts for supporting a number of workpieces.

In order to increase the yield of the deposited workpieces, it needs to arrange more posts on the workpiece carrier. However, the posts arranged on the workpiece carrier will become crowded. Thus, the deposition quality of the workpieces will be influenced.

Therefore, a workpiece carrier which can overcome the above-mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric view of a workpiece carrier according to a first embodiment.

FIG. 2 is a top planer view of the workpiece carrier of FIG. 1.

FIG. 3 is an isometric view of a tray of the workpiece carrier of FIG. 1.

FIG. 4 is a cutaway view of the workpiece carrier of FIG. 1.

FIG. 5 is a cross-section of the workpiece carrier of FIG. 1.

FIG. 6 is a top planer view of a deposition device according to a second embodiment.

### DETAILED DESCRIPTION

Embodiments will now be described in detail below with reference to the drawings.

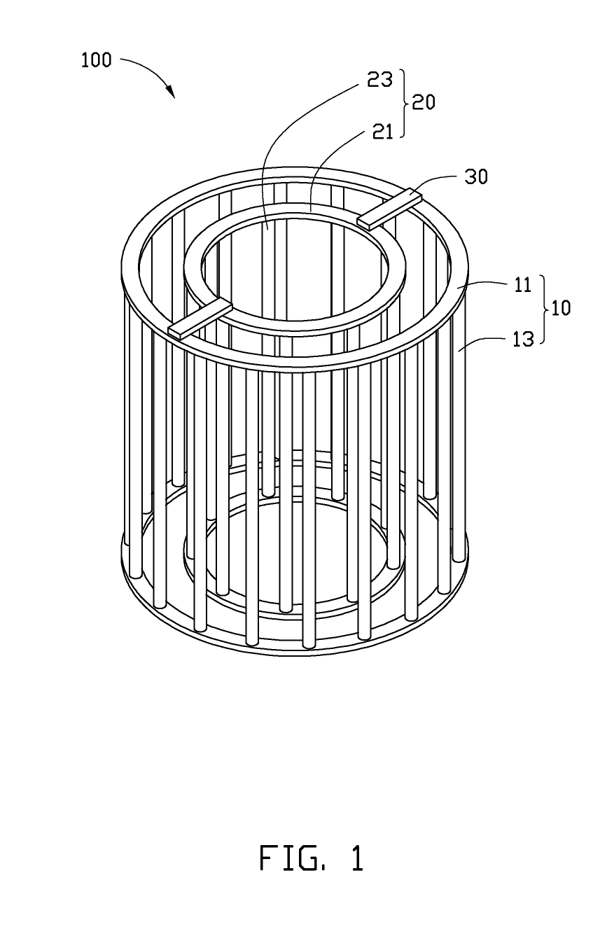

Referring to FIG. 1, a workpiece carrier 100 for supporting workpieces in accordance with a first embodiment is provided. The workpiece carrier 100 includes a first carrier 10, a second carrier 20, and two connecting arms 30.

The first carrier 10 has a first annular frame 11, and a plurality of first posts 13. The first posts 13 extend from the first annular frame 11, and substantially parallel to each other. In this embodiment, the first posts 13 are arranged on the first annular frame 11 with uniform intervals. Each of the first posts 13 is able to rotate around its central axis.

The second carrier 20 has a second annular frame 21, and a plurality of second posts 23. The second posts 23 extend from the second annular frame 21, and substantially parallel to each other. In this embodiment, the second posts 23 are arranged on the second annular frame 21 with uniform intervals. Each of the second posts 23 is able to rotate around its central axis.

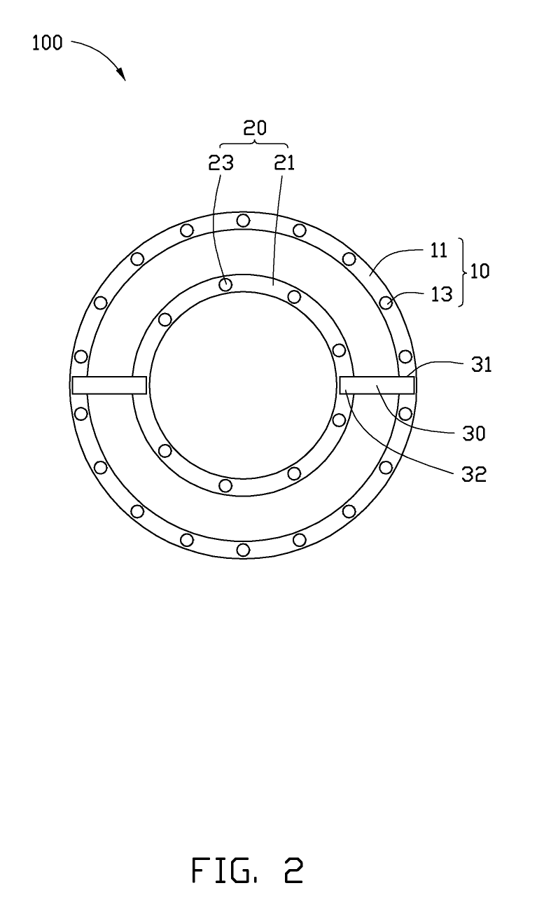

Referring to FIG. 2, the first carrier 10 and the second carrier 20 are concentric with a rotation axis. In this embodiment, the second carrier 20 is inside the first carrier 10. The first posts 13 of the first carrier 10 are surrounding the second carrier 20. Each of the first posts 13 and the second posts 23 are substantially parallel to each other, and substantially parallel to the rotation axis.

Referring to FIGS. 1-2, the connecting arms 30 are used to fixedly fasten the first carrier 10 and the second carrier 20. Therefore, the first carrier 10 and the second carrier 20 can simultaneously rotate around the rotation axis. In this embodiment, the connecting arms 30 are located on the top of the first carrier 10 and the second carrier 20, and opposite to each other. The connecting arms 30 are between the first carrier 10 and the second carrier, and fastening the first carrier 10 and the second carrier 20. Each of the connecting arms 30 has a first end 31, and a second end 32 opposite to the first end 31. The first end 31 is fastened to the first annular frame 11 of the first carrier 10. The second end 32 is fastened to the second annular frame 21 of the second carrier 20. Therefore, the first carrier 10 and the second carrier 20 cooperatively form the workpiece carrier 100.

The connecting arms 30 can fasten the first carrier 10 and the second carrier 20 with bolts and nuts, or pins and holes, or other mechanisms.

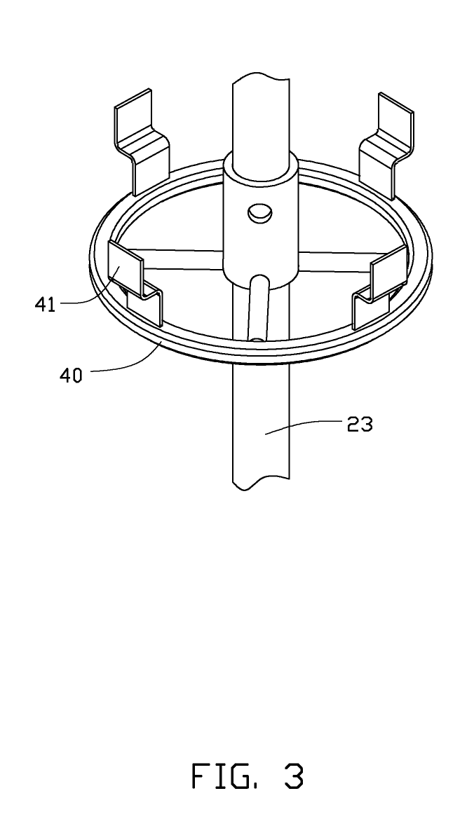

Furthermore, each of the first posts 13 and the second posts 23 is arranged with a number of trays 40 (see FIG. 3) for supporting workpieces. In this embodiment, the trays 40 mounted on the first posts 13 are similar to the trays 40 mounted on the second posts 23. Referring to FIG. 3, each of the trays 40 includes four fixing parts 41. The four fixing parts 41 surround the respective second post 23 with uniform intervals. Each of the fixing parts 41 is used for fixing a workpiece.

In this embodiment, the rotation axis of the first carrier 10 and the second carrier 20 is not simultaneously coaxial with any one of the first posts 13 and any one of the second posts 23. Therefore, workpieces supported on the first posts 13 and the second post 23 would not be blocked to be deposited.

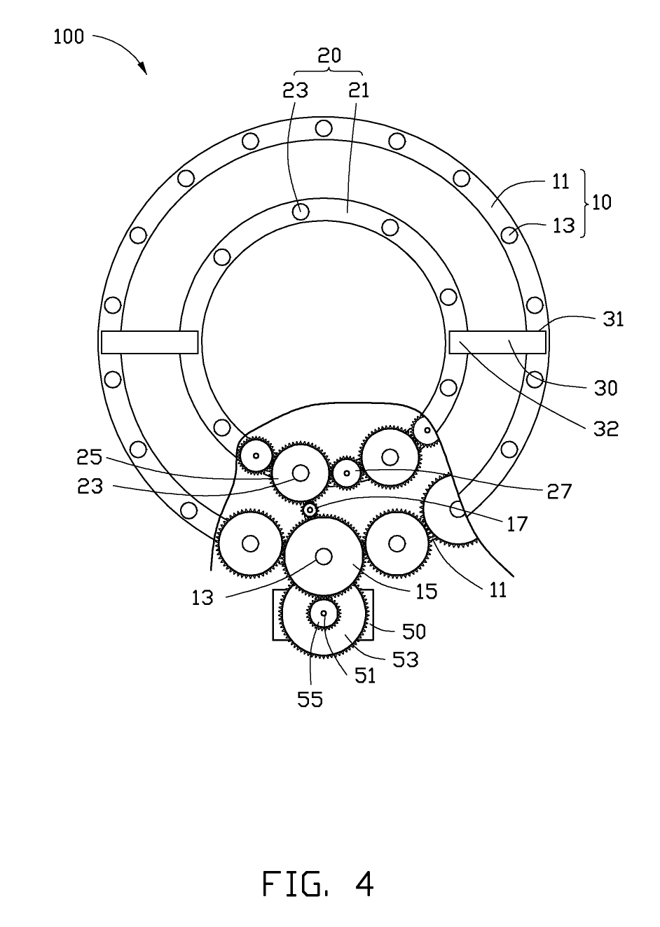

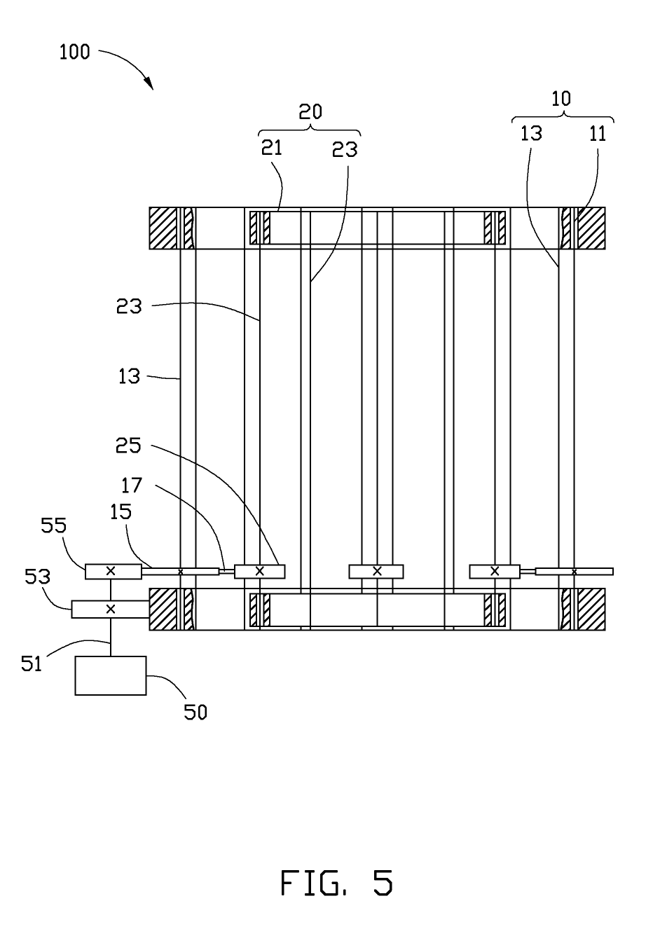

Referring to FIGS. 4-5, a gear transmission mechanism is equipped to the workpiece carrier 100, and located in the bottom of the workpiece carrier 100. In this embodiment, the gear transmission includes a first drive gear 53, a second drive gear 55, a plurality of first slave gears 15 and second slave gears 25, at least one first idler gear 17, and a plurality of second idler gears 27. The first slave gears 15 are coupled to the respective first posts 13. The second slave gears 25 are coupled to the respective second posts 23. The first slave gear 15 meshes with the second slave gear 25 with the first idler gear 17. Every two adjacent first slave gears 15 directly mesh with each other. Each two adjacent second slave gears 25 mesh with each other with one of the second idler gears 27. The second drive gear 55 engages with a first slave gear 15 coupled to the first posts 13. Therefore, the second drive gear 55 can drive each of the first posts 13 and second posts 23 to rotate around its own axis.

Furthermore, the workpiece carrier 100 includes a drive member 50. The drive member 50 drives the first carrier 10 and the second carrier 20 to simultaneously rotate around the rotation axis, and each of the first posts 13 and second posts 23 rotates around its own axis. In this embodiment, the drive member 50 includes a motor (not shown) having a drive shaft 51. The first drive gear 53 and the second drive gear 55 are coupled to the drive shaft 51. The first drive gear 53 engages with the teeth (see FIG. 5) formed on circumferential periphery of the first annular frame 11 of the first carrier 10. The gear ratio between the first drive gear 53 and the first carrier 10 is different from the gear ratio between the second drive gear 55 and the first slave gear 15. Therefore, the drive member 50 can drive the first carrier 10 and the second carrier 20 to simultaneously rotate around their common axis, and each of the first posts 13 and second posts 23 to rotate around its own axis.

It is to be understood that in an alternative embodiment, a belt transmission mechanism or a chain transmission mechanism can be equipped to the workpiece carrier 100.

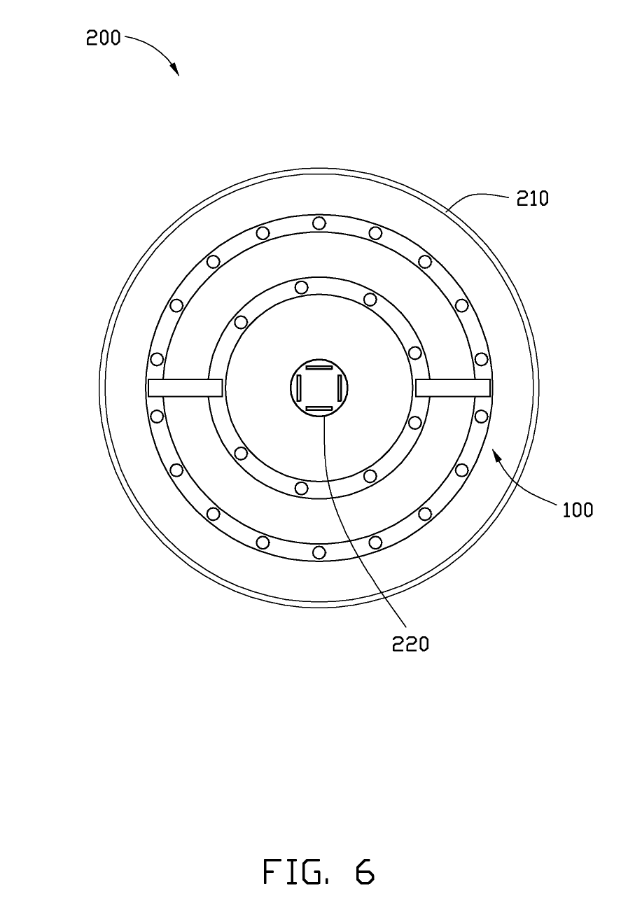

Referring to FIG. 6, a deposition device 200 in accordance with an alternative embodiment is provided. The deposition device 200 includes a coating chamber 210, a target 220, and a workpiece carrier 100.

The coating chamber 210 is a vacuum chamber. The target 220 is located in the center area of the deposition chamber 210. The target 220 is used to support deposition sources.

The workpiece carrier 100 is located in the coating chamber 210, and surrounding the target 220. The rotation axis of the workpiece carrier 100 is coaxial with the central axis of the deposition chamber 210.

In operation, the drive member 50 drives the workpiece carrier 100 rotate around the rotation axis, and each of the first posts 13 and second posts 23 rotates around its own central axis. Therefore, the workpieces supported on the first posts 13 and the second posts 23 can face the deposition sources on the target 220 in different directions. Accordingly, the deposition angel of the workpieces can be adjusted. Finally, the resultant material from the deposition source is deposited onto the workpieces from different direction.

Due to the first carrier 10 and the second carrier 20 being concentric to each other, the workpiece carrier 100 can have more posts arranged for supporting more workpieces. Therefore, the yield of the deposited workpieces can be substantially increased. Additionally, the posts can be arranged at suitable intervals. Therefore, it can greatly reduce the possibility of influence between different workpieces on different posts.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. A workpiece carrier, comprising:
a first carrier including a plurality of first posts substantially parallel to each other, each of the first posts being rotatable about a central axis thereof; and
a second carrier including a plurality of second posts substantially parallel to each other, each of the second posts being rotatable about a central axis thereof;
wherein the first carrier surrounds the second carrier therein; the workpiece carrier further comprises at least one connecting arm interconnected between the first carrier and the second carrier, such that the first carrier and the second carrier are jointly rotatable about a rotation axis.

2. The workpiece carrier of claim 1, wherein the at least one connecting arm comprises two connecting arms, the two connecting arms are located on opposite sides of the second carrier.

3. The workpiece carrier of claim 2, wherein the first carrier is fixed relative to the second carrier by means of the connecting arms.

4. The workpiece carrier of claim 1, wherein the first and second posts are substantially parallel to the rotation axis.

5. The workpiece carrier of claim 4, wherein the first and second posts surround the rotation axis.

6. The workpiece carrier of claim 1, further comprising a plurality of trays mounted on each of the first posts and the second posts for supporting workpieces.

7. The workpiece carrier of claim 1, further comprising a transmission gear mechanism, wherein the gear transmission mechanism includes a first drive gear, a second drive gear, a plurality of first slave gears coupled to the respective first posts, a plurality of second slave gears coupled to the respective second posts, and at least one idler gear meshed with one of the first slave gears and one of the second slave gears.

8. The workpiece carrier of claim 7, further comprising a drive member for driving the gear transmission mechanism.

9. The workpiece carrier of claim 8, wherein the drive member includes a motor having a drive shaft, the first and second drive gears are coupled to the drive shaft, the first drive gear engages with the first carrier, the second drive gear engages with one of the first slave gears.

10. The workpiece carrier of claim 9, wherein the gear ratio between the first drive gear and the first carrier is different from the gear ration between the second drive gear and the first slave gear.

11. A deposition device, comprising:
a deposition chamber; and
a workpiece carrier received in the deposition chamber, the workpiece carrier comprising:
a first carrier having a first annular frame, a plurality of first parallel posts extending from the first frame, and a plurality of first workpiece supporting trays mounted on each first post, the first carrier including a plurality of teeth formed on circumferential periphery of the first frame;
a second carrier received in the first carrier, the second carrier having a second annular frame, a plurality of second parallel posts extending from the second frame, and a plurality of second workpiece supporting trays mounted on each second post;
a connecting member fixedly interconnected between the first and second frames; and
a driving assembly comprising:
a plurality of first slave gears fixedly coupled to the respective first posts, each two adjacent first slave gears meshed with each other;
a plurality of second slave gears fixedly coupled to the respective second posts;
a first idler gear meshed with one of the first slave gears and one of the second slave gears;
a plurality of second idler gears each meshed with and between each two adjacent second slave gears;
a motor having a drive shaft;
a first drive gear meshed with the teeth of the first carrier;
a second drive gear meshed with one of the first slave gears, the first and second drive gears fixedly coupled to the drive shaft.

12. The workpiece device of claim 11, wherein the connecting member comprises two connecting arms, the two connecting arms are located on opposite sides of the second carrier.

13. The workpiece device of claim 12, wherein the first carrier is fixed relative to the second carrier by means of the connecting arms.

14. The workpiece device of claim 11, wherein the gear ratio between the first drive gear and the first carrier is different from the gear ration between the second drive gear and the first slave gear.

15. The workpiece device of claim 11, wherein each of the first and second workpiece supporting trays comprises a plurality of fixing parts for fixing workpieces.
